(19) United States
(12) Patent Application Publication
(10) Pub. No.: US 2015/0224855 A1
(43) Pub. Date: Aug. 13, 2015

(54) MOTOR VEHICLE GLAZING

(71) Applicant: AGC GLASS EUROPE, Louvain-La-Neuve (BE)

(72) Inventor: Denis Legrand, Wargnies (FR)

(73) Assignee: AGC GLASS EUROPE, Louvain-La-Neuve (BE)

(21) Appl. No.: 14/422,931

(22) PCT Filed: Aug. 5, 2013
(86) PCT No.: PCT/EP2013/066389

§ 371 Date: Feb. 20, 2015

(30) Foreign Application Priority Data
Aug. 21, 2012 (BE) BE 2012/0554

(51) Int. Cl. B60J 1/00; B32B 17/10; B32B 1/00; B60J 1/08

(52) U.S. Cl. CPC B60J 1/008; B60J 1/08; B32B 17/10036; B32B 1/00

(57) ABSTRACT

One subject of the invention is a meia-phenylenediamine compound having formula (I) below, the addition salts thereof with an acid and the solvates thereof: in which:•R represents a hydrogen or halogen atom; a C₁-C₄ alkyl group; a carboxyl group or a (C₁-C₄)alkoxycarbonyl group,•R1 represents a C₁-C₁₀(hydroxy)alkyl group, optionally interrupted with one or more non-adjacent oxygen atoms or non-adjacent NR′ substituents, substituted by a cationic CAT group,•R2 represents a hydrogen atom or a C₁-C₄(hydroxy)alkyl group,•R1 and R2 may form, together with the atom that bears them, a cationic heterocycle with 5 to 8 members,˜R′ represents a hydrogen atom or a C₁-C₄(hydroxy)alkyl group;•An″ represents an anion or a mixture of anions which are organic or inorganic and cosmetically acceptable.

The invention relates to laminated automotive glazing units.

Automotive glazing units are subject to continuously more demanding and often difficultly reconcilable requirements. This is especially the case of glazing units that, due to where they are fitted in the vehicle, may be subjected to particular mechanical stresses. By way of example, side door windows which are not engaged in a frame that encircles them, such as in certain cabriolets, must be able to withstand without damage substantial stresses, for example such as those experienced when the door is slammed shut.

Side windows conventionally consist of relatively thick, monolithic glass sheets. However, for their most advanced models manufacturers would like to provide glazing units having the best available properties. These are especially glazing units having anti-intrusion and acoustic attenuation qualities and athermic properties, etc. In practice, to obtain such glazing units it is necessary to use laminated products.

Moreover, the mechanical strength required for the cases envisioned according to the invention means that these laminated glazing units must be just as strong as tempered glass.

It is very conventional for side door windows to be movable and they must be made to move by mechanical parts that are fastened to their bottom portion, which is hidden in the door.

Monolithic sheets may be fastened by adhesively bonding U-brackets straddling the lower edge of the glazing unit. These U-brackets are optionally adhesively bonded but most often they are fastened by means of devices that require the glass sheet to be machined, especially drilled with holes, the holes enabling the passage of nuts, rivets or the like, which guarantee a particularly strong assembly. For a laminated glazing unit, these fastening modes are undesirable insofar as the pressure initially exerted on the glazing unit may lead the material of the interlayer sheet to deform, and over time this fastening to eventually come loose.

Apart from side windows, fastening additional elements to a glazing unit, for example the wiping system of the rear windshield, poses problems of a similar nature. The system must be securely attached and results in a high pressure being exerted on the glazing unit in the location of the passage, for example the axis of the system.

Untempered glass sheets can undergo the machining required to enable such an attachment without any risk of breaking; they can in particular be drilled with holes. In contrast, it is not possible to machine tempered glass sheets. When the glazing unit is monolithic, the machining intended for these attachments is carried out before the temper which is carried out immediately after any bending operations. Associating two tempered sheets that have been machined before being bent/tempered causes a problem as the machined portions do not overlap perfectly. The axes of the holes in each of the sheets must be perfectly aligned, which in practice is not possible with sheets that have already been bent. The axes are necessarily slightly offset, exposing the sheets to difficulties that may lead to the assembly weakening.

The invention proposes to respond to these difficulties in the way forming the subject matter of claim 1.

By their composition, glazing units according to the invention may provide the advantages of laminated glazing units while guaranteeing in particular the necessary mechanical strength of tempered monolithic glazing units.

The two sheets of the assembly are very different in their structure. The curved exterior sheet is sufficiently thick so that when joined to the thin interior sheet, it imposes its shape on the latter. It is tempered or semi-tempered in order to provide the required strengths. Tempered glass has, under standard conditions, an instantaneous flexural strength of about 60 MPa; the instantaneous flexural strength of semi-tempered glass is only about 40 MPa.

Joining a curved sheet to a sheet that is not, or the curvature of which is not significant, is subject to conditions that especially depend on their respective properties, their thicknesses to start with. In the case of “low-weight” laminated glazing units, these conditions are especially detailed in patent application PCT/EP2012/061557 filed 18 Jun. 2012, incorporated here by reference. Whether or not the glazing unit is a low-weight glazing unit, these conditions are moreover detailed below.

If the curvature of the joined sheets is significant, the ratio of the thicknesses of the curved sheet to the thicknesses of the sheet that is not must preferably be at least 3/1 and advantageously at least 4/1. Although there is no upper limit to this ratio, practical conditions related to the total thickness of the glazing unit and to those of each of the sheets nevertheless lead to a ratio that in practice does not exceed 12/1.

The thickness ratio advantageously increases as the radius of curvature imposed on the thin sheet, which is essentially flat before assembly, decreases. This is for example the case when the radius of curvature is lower than 3 m and above all if it is lower than 1.5 m.

The aforementioned PCT patent application in particular mentions the fact that the surface stresses induced in the thin sheet when it is joined to the thick sheet must in general not exceed about 50 MPa. The stress withstood depends on curvature and increases as radius of curvature decreases. The application in question gives by way of example the stresses induced for different thicknesses depending on this radius of curvature.

For models for which manufacturers are not seeking to decrease glazing-unit weight, the thick sheets according to the invention may be as much as 5 mm or more in thickness. In contrast, for glazing units for which a limited weight is desired, the thickness of the tempered sheet preferably does not exceed 2.4 mm and advantageously not 2.1 mm.

For the thin sheet, the choice of its thickness is conditioned by its ability to match the curvature of the thick sheet. The smaller its thickness, the easier it is to impose this deformation thereon. The thickness of this sheet is advantageously at most 0.8 mm and preferably at most 0.6 mm. It is possible to produce sheets as thin as 0.1 mm, nevertheless for the sake of ease of implementation, it is preferable for the sheet to have a thickness of at least 0.2 mm.

Shaping glass sheets of very small thickness is a delicate process and causes problems with reproducibility. Insofar as the final curvature of the laminated glazing unit is that imposed by the thick sheet, it is neither necessary nor advantageous for the thin sheet to have a curvature before its assembly.

In order to give the sheets the mechanical strength that, at least for the thin sheet, especially allows them to undergo the bending required by the assembly process, without running the risk of exceeding withstandable stresses, the threshold of these stresses is advantageously increased by tempering these sheets.

Glass sheets are most often thermally tempered especially for reasons of cost, advantage being taken of the temperature reached in the production process. A thermal temper is obtained by rapidly cooling the faces of the sheet, by blowing air at room temperature onto them. The surface of the sheet cools first whereas its bulk cools more slowly. This operation is that which leads the thick sheet to the tempered or semi-tempered state depending on the conditions of implementation of this operation.

For very thin sheets, the temperature gradient between the surface and core during forced cooling is often not steep enough to achieve the sought-after stress level. For the reasons given above, the thin sheet is preferably chemically tempered. This type of temper allows the sought-after stresses to be obtained even with sheets of small thickness. The chemical temper is carried out under conditions that are conventional for this type of treatment, especially by exchanging sodium ions for potassium ions on the surface of the sheet.

The arrangement according to the invention, whereby only the thick sheet is fastened and optionally machined, prevents difficulties due to the lamination and to the presence of the thin sheet. The glazing unit behaves like a monolithic glazing unit in its non-laminated portion and elsewhere preserves all the functionalities that may be obtained with laminated glazing units.

Laminated glazing units have been previously described in which the two sheets are not rigorously coextensive. This is for example the case in patent EP 1 171 294, which relates to a glazed roof comprising a series of photovoltaic cells incorporated into a laminated portion, the roof moreover comprising a monolithic portion without cells. The aim of the presence of the laminated portion in this case is the incorporation of these functional elements into a structure that protects them. The sheet, which covers only one portion of the glazing unit, does not have a particular thickness. Furthermore, in this prior embodiment the exterior sheet in its non-laminated portion is not intended for fastening the glazing unit. This roof glazing unit is customarily fastened to the body by adhesive bonding, either via the portion that is laminated or via the portion that is not.

Laminated assemblies in which the edges of one of the glass sheets are slightly set back from those of the other sheet are also known from the prior art. This arrangement is for example employed when it is envisioned to adhesively bond the glazing unit via the sheet using the uncovered edge. As in the preceding case, the arrangements described do not include the use of sheets assembled under the conditions of the invention.

The partially laminated structure of glazing units according to the invention allows the glazing unit to be fastened even if this requires the unit to be machined, for example with holes intended to interact with mechanical means. The size of this non-laminated portion may be relatively limited relative to the total area of the glazing unit. It is not necessary, or even desirable, for this portion to extend further than is actually necessary to produce the means for fastening the thick sheet. In practice, the non-laminated portion preferably represents no more than 20% of the area of the thick sheet, and particularly preferably no more than 10 %of this area.

In order to allow the fastening means of the glazing unit to be suitably arranged, the non-laminated area will nevertheless be a certain size. It is preferably at least 0.5% of the area of the largest sheet, and more often at least 1% of this area.

In certain respects, the presence in the glazing unit according to the invention of a sheet that undergoes no other heat treatment than that used to join the sheets to their interlayer makes it easier to insert means providing additional functionalities. This is in particular the case for means sensitive to high temperatures. The assembly operation is carried out in the conventional way and the temperatures reached are no higher than those required to allow the interlayer sheet to adhesively bond. These temperatures are ordinarily about 120-130° C., and ordinarily do not exceed 150° C.

Under these conditions it is possible to use the thin sheet as a carrier, especially of thin heat-sensitive layers. This is for example the case of low-emissive layers comprising metal layers that reflect IR. The layers in question are deposited by vacuum cathode sputtering. In the implementation of these processes, if the sheet is so thin that it cannot itself guarantee its planarity during the deposition, this sheet may be placed on a thicker sheet the only function of which is to support the thin sheet.

In heat treatments such as bending/tempering treatments, temperatures as high as about 650-700° C. are reached. At these temperatures, metal layers, especially layers based on silver, must be protected by particular systems that are sometimes difficult to produce. Applying the layers in question to a previously bent glass sheet raises other problems, especially with the uniformity of such coatings, such that it is generally preferred to apply these layers to flat sheets, and therefore to subject these layers to the thermal conditions applied to shape the glass sheet. However, such treatment may substantially alter the properties of the layers, and to prevent such alterations said systems of layers must have very particular structures. In contrast, applying layers that are relatively susceptible to heat to sheets according to the invention that are not subjected to these treatments, prevents any alteration of these layers.

In practice, if it is desired to use this type of layers, both solutions are possible. The layers are either on the thick sheet (or more precisely on the portion of the latter that is then laminated, i.e. that makes contact with the interlayer) and in this case they are exposed to the bending/tempering operations, or else these layers are on the thin sheet on that face of the latter which makes contact with the interlayer.

The invention is described in detail by referring to the mosaic, in which:

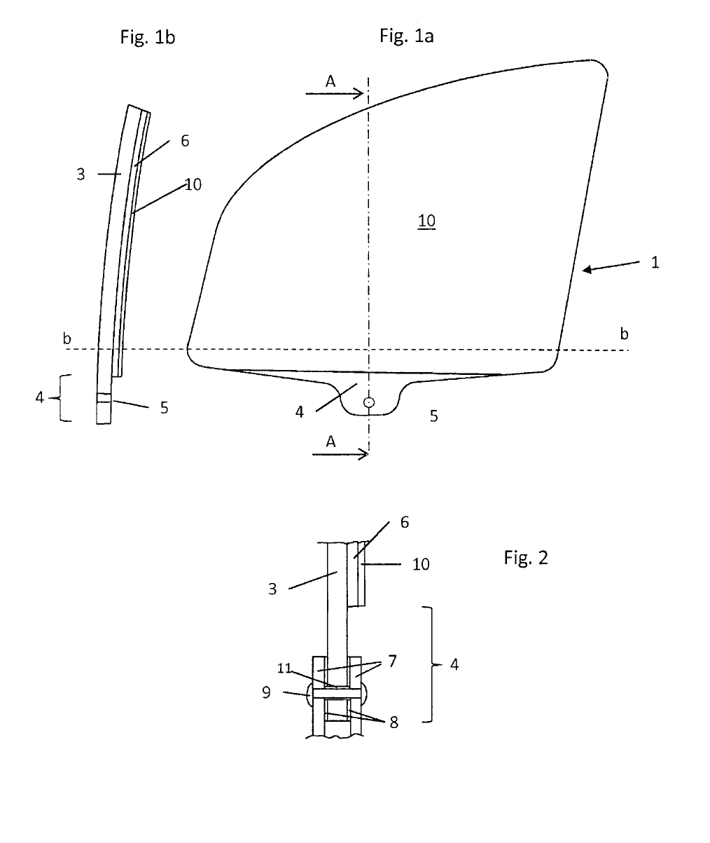

FIG. 1a is a schematic front view of a glazing unit according to the invention;

FIG. 1b is a side view, of a cross section along A-A, of the glazing unit in figure la; and

FIG. 2 is a partial cross-sectional view of the portion of a glazing unit according to the invention showing the positioning of means for fastening the glazing unit.

FIG. 1a shows a movable side window 1 intended to slide in or over rails placed on the body of a vehicle. In its movement, the glazing unit, once lowered, retracts, for example into a door of the vehicle. The glazing unit may, if required, be guided only by rails integrated into the door. It is in particular for these “frameless” glazing units that the mechanical strength of the unit must be correctly ensured. In the completely raised position, the bottom portion of the glazing unit remains masked by said door, for example up to the level represented by the dotted line b-b.

The glazing unit, as shown in FIG. 1b, comprises an exterior sheet 3 made of tempered or semi-tempered glass. This sheet is bent before it is joined to the other components of the glazing unit. A second glass sheet 10 is associated with the sheet 3 by means of an interlayer sheet 6 made of a thermoplastic conventionally used for this purpose. The thermoplastic sheet is for example a sheet of polyvinyl butyral (PVB). The sheet 10 is curved because it is joined to the sheet 3. Before it is joined, the sheet 10 is substantially planar. The deformation caused by the assembly operation is maintained by the strong adherence of the interlayer sheet to the two glass sheets and by the strength of the sheet 3, which is comparatively thick relative to the sheet 10.

For a “low-weight” glazing unit, the respective thickness of the sheets is for example 2.1 mm for sheet 3 and 0.4 mm for sheet 10. The interlayer sheet may be made of PVB of standard thickness (0.76 mm or 0.38 mm for example). However, other conventional interlayers (especially EVA interlayers) of similar or smaller thickness are also usable.

The total thickness of glass in this glazing unit is thus 2.5 mm. Conventional monolithic side windows have a thickness of about 4 mm or, for the thinnest, of about 3.2 mm. The laminated portion of the glazing unit according to the invention is therefore relatively lighter than conventional monolithic glazing units.

As the figures show, the lamination does not completely cover the glazing unit 1. The thin sheet 10 and the interlayer sheet that is associated therewith leave a portion 4 of the sheet 3 uncovered.

The portion of the glazing unit 1 that is not masked by the body, and that is located above the dotted line b-b, is entirely laminated. It therefore ensures that the glazing unit preserves all the properties expected of this portion exposed to mechanical factors such as shocks, independently of whether they originate from the exterior or the interior of the vehicle. In particular, the glazing unit has the anti-intrusion or anti-ejection properties conventionally associated with laminated glazing units. It also has the acoustic properties of said laminated glazing units, which properties especially benefit from the difference in the thickness of the glass sheets making up said glazing unit, and which may even be improved by using specific interlayers to increase acoustic attenuation. These interlayers are for example sheets composed of three PVB layers, the central layer being over-plasticized relative to the two layers making contact with the glass sheets.

In the portion of the glazing unit masked from sight by the body, the lamination is not complete. The portion 4 comprises only the sheet 3. It is in this portion that the sheet 3 receives the fastening means. In the drawing shown in the figures, the sheet 3 is machined. It comprises a cylindrical hole 5 passing through the sheet 3. This hole 5 is formed before the sheet is tempered.

FIG. 2 illustrates by way of indication one way of fastening the glazing unit 1. The portion 4 of the glazing unit used to fasten the latter is sandwiched between two plates 7 held clamped against the glass sheet 3 by a fastening means 9, a rivet in the drawing. However, any other analogous means would suffice. Between the plates 7 and the glass sheet, a sheet 8 and a sleeve ii of resilient material prevent the glass 3 from making contact with the metal of the plates 7.

The chosen drawing shows a single through-hole 5. A plurality of fastening points of given nature may be arranged in the portion 4 of the glazing unit 3.

If the machining used is a single through-hole, it is also possible to replace it by any equivalent means, for example a blind hole in which a pad or pin of corresponding shape and size, borne by or forming an integral portion of plates clamped to the glass by means (not shown) arranged below the bottom of the sheet 3, is inserted.

FIG. 2 does not show the conventional means linked to the plates 7, which means are connected to the devices for moving the glazing unit.

1. A laminated automotive glazing unit comprising an exterior glass sheet that is curved and tempered and a thin glass interior sheet that is also tempered, these sheets being joined by means of a thermoplastic interlayer sheet,
wherein
the glazing unit is configured to receive mechanical moving and/or fastening means,
a portion of the exterior sheet is not covered by the thin interior sheet, and
the glazing unit is fastened in the zone not covered by the thin sheet.

2. The glazing unit as claimed in claim 1, wherein a ratio of the respective thicknesses of the exterior sheet to the thin interior sheet is at least 3/1.

3. The glazing unit as claimed in claim 1, wherein the exterior sheet has a thickness that is no larger than 5 mm.

4. The glazing unit as claimed in claim 1, wherein the thin interior sheet has a thickness that is no larger than 0.8 mm.

5. The glazing unit as claimed in claim 1, wherein the thin glass interior sheet has a thickness that is no smaller than 0.2 mm.

6. The glazing unit as claimed in claim 1, wherein the thin glass interior sheet does not have a significant curvature before it is joined to the curved exterior glass sheet.

7. The glazing unit as claimed in claim 1, wherein the thin glass interior sheet is chemically tempered.

8. The glazing unit as claimed in claim 1, wherein the thin glass interior sheet is coated on its face turned toward the interlayer sheet with a set of functional layers having athermic properties.

9. The glazing unit as claimed in claim 1, wherein a portion where the sheets do not overlap represents no more than 20% of the area of the exterior sheet.

10. The glazing unit as claimed in claim 1, wherein portions where the sheets do not overlap represents at least 0.5% of the area of the exterior sheet.

11. The glazing unit as claimed in claim 1, wherein the exterior sheet comprises, in the non-laminated portion, a hole configured to receive means for fastening/moving the glazing unit.

12. The glazing unit as claimed in claim 1, wherein the glazing unit forms a movable side window.

13. The glazing unit as claimed in claim 1, wherein the glazing unit is a carrier for additional elements requiring the glazing unit to be machined.
